(19) United States
(12) Patent Application Publication
(10) Pub. No.: US 2016/0063434 A1
(43) Pub. Date: Mar. 3, 2016

(54) APPARATUS AND METHOD FOR EARLY DETECTION OF ABNORMALITY

(71) Applicant: SAMSUNG SDS CO., LTD., Seoul (KR)

(72) Inventors: Sungil KIM, Seoul (KR); Yongro PARK, Seongnam-si (KR); Gowun JEONG, Seoul (KR); Yoonheok KIM, Seoul (KR); Sung Woo LEE, Seongnam-si (KR); Jewoun RYU, Seongnam-si (KR)

(73) Assignee: SAMSUNG SDS CO., LTD., Seoul (KR)

(21) Appl. No.: 14/582,805

(22) Filed: Dec. 24, 2014

(30) Foreign Application Priority Data
Aug. 27, 2014 (KR) 10-2014-0112321

(51) Int. Cl. G06Q 10/08

(52) U.S. Cl. CPC G06Q 10/0833

(57) ABSTRACT

Disclosed are an apparatus and method for detecting an abnormality early. An apparatus for detecting the abnormality early includes a similar case selector configured to select similar cases associated with a monitored target from among previous case data, a data collector configured to collect status information of the monitored target, an abnormality detector configured to generate a baseline for detecting the abnormality of the monitored target from case data classified as normal among the previous case data and compare the baseline with the collected status information to detect whether the monitored target has the abnormality, and a predictor configured to, when it is detected that the monitored target has the abnormality, compare each of the selected similar cases with the collected status information to select an optimum similar case associated with the monitored target among the similar cases, and to predict a future situation development of the monitored target based on the optimum similar case.

### CROSS-REFERENCE TO RELATED APPLICATION

This application claims priority to and the benefit of Korean Patent Application No. 10-2014-0112321, filed on Aug. 27, 2014, the disclosure of which is incorporated herein by reference in its entirety.

### BACKGROUND

1. Field

Embodiments of the present disclosure relate to a technique for detecting and predicting an abnormality of a monitored target early through a combination of real-time collected data and previous data.

2. Discussion of Related Art

Early or real time detection of abnormal situations is one of core techniques for reducing cost and managing risk in various transportation scenarios. For example, in a fourth-party logistics (4PL), accurate prediction of logistical problems is essential to reducing response cost and satisfying customers. Thus, 4PL providers are making efforts to secure visibility of logistics by introducing a real-time vessel tracking technique, etc. However, little research has been conducted on an information fusion analysis model for effectively utilizing mass data that is input in real time to predict logistical problems early.

### SUMMARY

The present disclosure is directed to quickly detecting an abnormal situation of a monitored target and effectively predicting a future situation development by applying real-time data that is continuously generated to a similar case that is derived from a similar-based methodology.

According to an aspect of the present disclosure, there is provided an apparatus for detecting an abnormality early, the apparatus including: a similar case selector configured to select similar cases associated with a monitored target from among previous case data; a data collector configured to collect status information of the monitored target; and a predictor configured to compare each of the similar cases with the collected status information to select an optimum similar case from among the similar cases, and to predict a future situation development of the monitored target based on the optimum similar case.

The similar case selector may select the similar cases based on case-based reasoning using similarities between feature values of the previous case data and a feature value of the monitored target.

The apparatus may further include an abnormality detector configured to compare case data classified as normal among the previous case data with the status information of the monitored target to detect an abnormality of the monitored target.

The abnormality detector may generate a baseline for detecting the abnormality of the monitored target from the case data classified as normal and compare the baseline with the collected status information to detect whether the monitored target has the abnormality.

The baseline may be one of an average value and a median value of the case data classified as normal.

The abnormality detector may determine that the monitored target has the abnormality when a difference between the collected status information and the baseline is outside a normal range.

The abnormality detector may calculate a difference between the collected status information and the baseline in a preset comparison section.

The abnormality detector may output an alarm message when it is determined that the monitored target has the abnormality.

The predictor may select the optimum similar case when the abnormality detector detects that the monitored target has abnormality.

The predictor may compare a pattern of each of the similar cases with a pattern of the collected status information and select, as the optimum similar case, a similar case having a pattern of highest similarity to a pattern of the status information.

The predictor may calculate a maximum value of similarity to the pattern of the collected status information for the pattern of each of the similar cases while moving the pattern of each of the similar cases in the same plane as the pattern of the collected status information and select, as the optimum similar case, a similar case having a largest maximum value of similarity.

The predictor may predict the future situation development of the monitored target based on a pattern and a feature value of the selected optimum similar case.

The monitored target may be a moving object, the previous case data may be previous operation case data of the moving object, and the status information may be time-based location information of the moving object.

According to another aspect of the present disclosure, there is provided a method of detecting abnormality early, the method including: selecting similar cases associated with a monitored target from among previous case data; collecting status information of the monitored target; comparing each of the similar cases with the collected status information to select an optimum similar case from among the similar cases; and predicting future situation development of the monitored target based on the optimum similar case.

The selecting of the similar cases may include selecting the similar cases based on case-based reasoning using similarities between feature values of the previous case data and a feature value of the monitored target.

The method may further include, before the selecting of the optimum similar case, comparing case data classified as normal among the previous case data with the status information of the monitored target to detect an abnormality of the monitored target.

The detecting of whether the monitored target has the abnormality may further include: generating a baseline for detecting the abnormality of the monitored target from the case data classified as normal; and comparing the baseline with the collected status information.

The baseline may be one of an average value and a median value of the case data classified as normal.

The comparing may include determining that the monitored target has the abnormality when a difference between the collected status information and the baseline is outside a normal range.

The comparing may include calculating a difference between the collected status information and the baseline in a preset comparison section.

The detecting of whether the monitored target has abnormality may further include outputting an alarm message when it is determined that the monitored target has the abnormality.

The selecting of the optimum similar case may include selecting the optimum similar case when the abnormality detector detects that the monitored target has the abnormality.

The selecting of the optimum similar case may include comparing a pattern of each of the similar cases with a pattern of the collected status information and selecting, as the optimum similar case, a similar case having a pattern having of similarity to a pattern of the status information.

The selecting of the optimum similar case may include calculating a maximum value of similarity to the pattern of the collected status information for the pattern of each of the similar case while moving the pattern of each of the similar cases in the same plane as the pattern of the collected status information and selecting, as the optimum similar case, a similar case having a largest maximum value of similarity.

The predicting may include predicting the future situation development of the monitored target based on a pattern and a feature value of the selected optimum similar case.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating a monitoring system according to an embodiment of the present disclosure;

FIG. 2 is a block diagram illustrating a detailed configuration of an apparatus for detecting abnormality early according to an embodiment of the present disclosure;

FIG. 3 is an exemplary diagram illustrating status information of a monitored target that is collected by a data collector of the apparatus for detecting abnormality early according to an embodiment of the present disclosure;

FIG. 4 is a graph showing a baseline established for a route of a vessel that is shown in FIG. 3;

FIGS. 5 and 6 are exemplary diagrams of cases of delivery delays that may occur when location information of a vessel that is being monitored by an abnormality detector of the apparatus for detecting abnormality early is compared with a baseline according to an embodiment of the present disclosure;

FIG. 7 is an exemplary diagram illustrating an output of a warning message from an abnormality detector of the apparatus for detecting abnormality early according to an embodiment of the present disclosure;

FIG. 8 is a graph illustrating an example in which a predictor of the apparatus for detecting an abnormality early selects an optimum similar case and compares a vessel that is being monitored with the case; and

FIG. 9 is a flowchart illustrating a method of detecting an abnormality early according to an embodiment of the present disclosure.

### DETAILED DESCRIPTION OF EXEMPLARY EMBODIMENTS

Hereinafter, embodiments of the present disclosure will be described in detail with reference to the accompanying drawings. The following detailed description is provided for better understanding of a method, an apparatus, and/or a system that are disclosed in this specification. However, this is merely exemplary, and the present disclosure is not limited thereto.

In describing embodiments of the present disclosure, when it is determined that detailed description of known techniques associated with the present disclosure would unnecessarily obscure the gist of the present disclosure, the detailed description thereof will be omitted. Also, the terms described below are defined in consideration of the functions in the present disclosure, and thus may vary depending on an intention or custom of a user or operator. Accordingly, the terms will be defined based on the whole specification. The terminology used herein is only for the purpose of describing embodiments of the present disclosure, and should not be restrictive. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

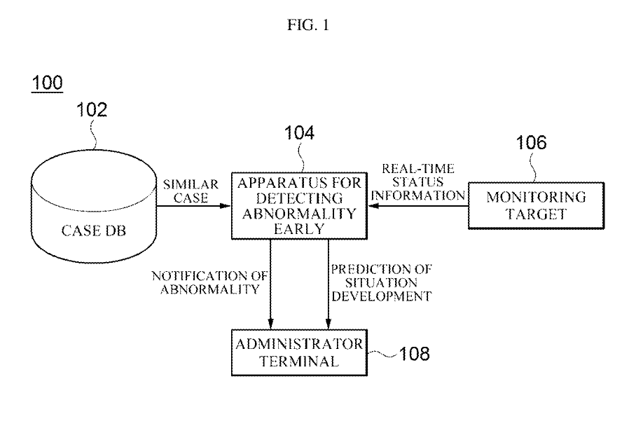

FIG. 1 is a block diagram illustrating a monitoring system 100 according to an embodiment of the present disclosure. The monitoring system 100 according to an embodiment of the present disclosure detects an abnormality of a monitoring target using status information that is acquired in real time from the monitored target and previous case data that is previously stored, and predicts future situation development. For example, the monitoring system 100 according to an embodiment of the present disclosure may acquire real-time location information of a moving object such as a vessel or aircraft, compare the acquired real-time location information with past case data, and predict whether the moving object can arrive at a destination at a scheduled time. However, embodiments of the present disclosure are not limited thereto and may be used in various fields such as prediction of equipment failure or disaster.

As shown in FIG. 1, the monitoring system 100 according to an embodiment of the present disclosure includes a case database 102 and an apparatus 104 for detecting abnormality early.

The case database 102 stores and manages the previous case data that is associated with the monitored target. In an embodiment, the case database 102 may store previous operation case information of the moving object. For example, when the moving object is a logistics vessel, the previous operation case information may be a shipping company, a route, vessel identification information (a vessel name), a point of departure (or a port of departure), a departure time, a point of arrival (or a port of arrival), an arrival time, or location information for each operation time of the vessel.

The apparatus 104 for detecting abnormality early collects real-time status information of the monitored target 106 and monitors whether the monitored target 106 has abnormality using case data that is stored in the case database 102. When it is determined that the monitored target 106 has an abnormality, the apparatus 104 for detecting abnormality early may display an alarm message on a manager terminal 108 and the like. In addition, the apparatus 104 for detecting abnormality early may be configured to predict a future situation of the monitored target 105 having abnormality and provide information on the future situation to the manager terminal 108 or store the information in the case database 102. In an embodiment, the various elements of apparatus 100 are implemented via a CPU, hardware processor, or other computing device including further electronic hardware.

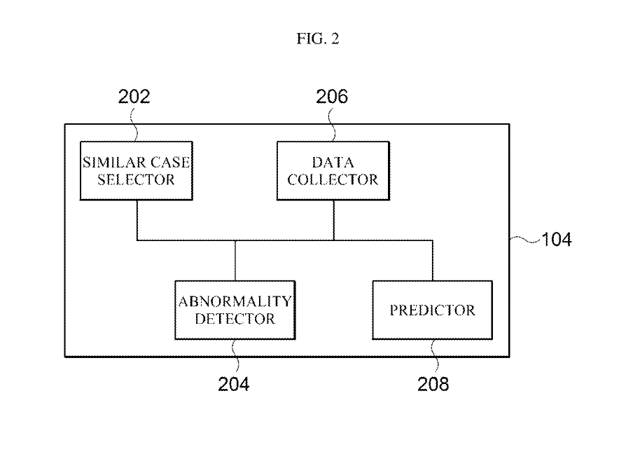

FIG. 2 is a block diagram illustrating a detailed configuration of an apparatus 104 for detecting abnormality early according to an embodiment of the present disclosure. As shown in FIG. 2, the apparatus 104 for detecting an abnormality early according to an embodiment of the present disclosure includes a similar case selector 202, a data collector 204, an abnormality detector 206 and a predictor 208. In an embodiment, the similar case selector 202, the data collector 204, the abnormality detector 206, and the predictor 208 are executed by at least one CPU or at least one hardware processor.

The similar case selector 202 selects a similar case that is associated with the monitored target from among previous case data that is stored in the case database 102. In an embodiment, the similar case may be referred to as a case. In an embodiment, the similar case selector 202 may select the similar case based on case-based reasoning (CBR) using similarities between a feature value of the previous case data and a feature value of the monitored target. For example, when the monitored target 106 is a moving object, the feature value may include one or more of a delivery company that operates the moving object, a route, identification information (a vessel name or flight name) of the moving object, a point of departure, a departure time, a point of arrival, and an arrival time. In this case, the similar case selector 202 may select, as the similar case, a case in which a moving object operates on the same route as and at a similar time to the monitored target 106 from among previous operation cases using the case-based reasoning. Parameters such as feature values upon which the case-based reasoning is based and a weight of each of the feature values may be selected appropriately in consideration of a feature of the monitored target 106, a feature of the previous case data, and the like. That is, it is noted that embodiments of the present disclosure are not limited to a specific algorithm for selecting the similar case.

The data collector 204 collects status information of the monitored target 106. For example, when the monitored target 106 is a moving object, the status information may be time-based location information of the moving object.

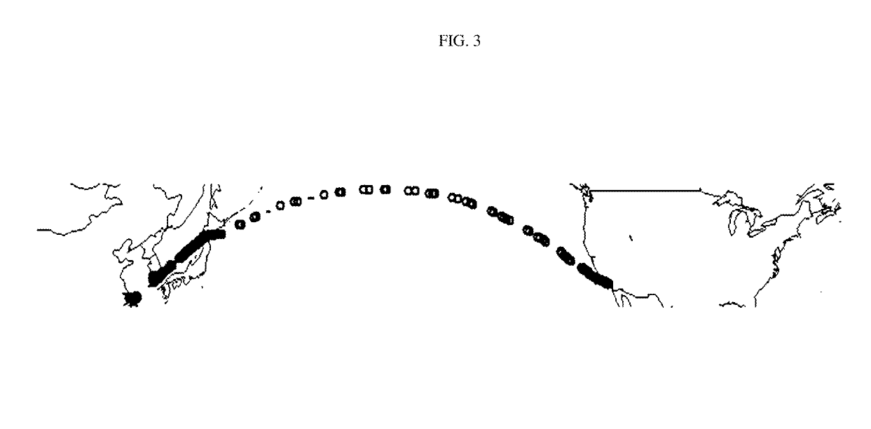

FIG. 3 is an exemplary diagram illustrating status information of a monitored target 106 that is collected by a data collector 204 of the apparatus 104 for detecting abnormality early according to an embodiment of the present disclosure. As shown in FIG. 3, location information of a vessel that is operating from China to the United States is displayed as a dot on a map over time.

The abnormality detector 206 generates a baseline from case data classified as normal among the previous case data that is stored in the case database 102. In an embodiment of the present disclosure, a baseline is used for the abnormality detector 206 to determine whether the monitored target 106 has an abnormality. That is, when status information collected according to a feature of the monitored target 106 exceeds or falls below the baseline by a certain range or more, the abnormality detector 206 may determine whether the monitored target 106 has an abnormality.

In an embodiment, the baseline may be one of an average value or a median value of time-based location information that is included in case data (normal case data) that is classified as normal among the previous case data stored in the case database 102. In this case, the normal case data may be the same as or different from the above-described similar case, and the normal case data may have a range greater or less than the similar case.

For example, when the monitored target 106 is a moving target, the normal case data may be time-based location information of a moving object that has operated normally without delay among the previous case data of the moving object that has operated on the same route. In this case, the baseline serves as a milestone of delivery delay. Delivery delay or logistical problems may be determined when the location information of a vessel generated in real time is compared with the baseline. In other words, the baseline provides a lead time for the route.

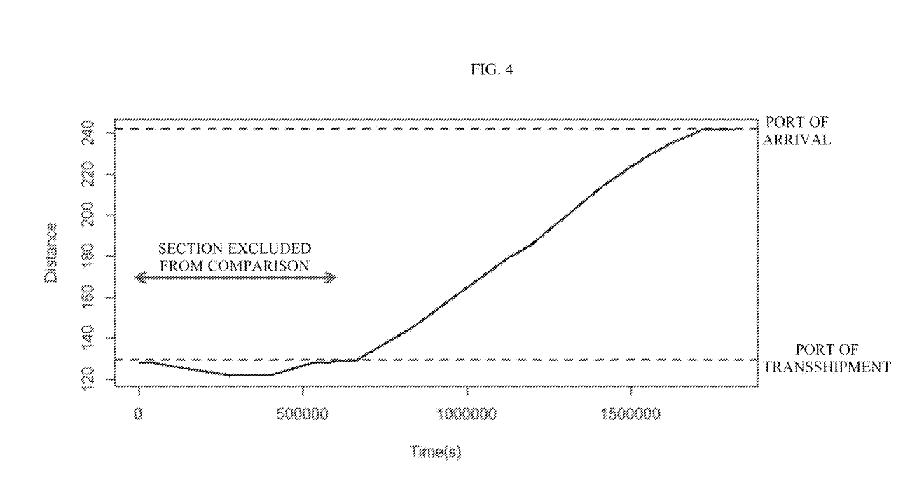

FIG. 4 is a graph showing a baseline established for a route of a vessel that is shown in FIG. 3. In the graph shown in FIG. 4, an X axis indicates a time (in seconds) that has passed since departure from a port of departure, and a Y axis indicates a distance from the port of departure. In FIG. 4, the unit of the distance is expressed as longitude and may vary according to embodiments.

When the base line is set as described above, the abnormality detector 206 compares the baseline with the collected status information to detect whether the monitored target 106 has an abnormality. As described above, when a difference between the collected status information and the baseline is outside a normal range, the abnormality detector 206 may determine that the monitored target 106 has an abnormality.

For example, when the monitored target 106 is a moving object, the abnormality detector 206 may compare the collected location information with the baseline and determine that the delivery delay has occurred when the collected location information falls below the baseline.

On the other hand, the abnormality detector 206 may set a section for comparison and calculate a distance between status information collected in the comparison section and the baseline, instead of comparing the baseline and the collected status information in an entire section of the baseline.

For example, it is assumed that the monitored target 106 is a vessel for carrying cargo. For most international transportation, logistics is transported using a plurality of vessels via a port of transshipment rather than using one vessel. However, since the position tracking data of the vessel is collected based on one vessel, for example, when specific cargo is carried using another vessel from a port of departure to a port of transshipment and loaded to a monitored target vessel in the port of transshipment, it is difficult to reflect the baseline in location information of the monitored target vessel from the port of departure to the port of transshipment. In order words, an omitted section from the port of departure to the port of arrival should be excluded. Accordingly, the abnormality detector 206 may be configured to select a reliable comparison section first before using real-time location data. For example, in FIG. 4, a left portion (indicated by a double arrow) of the graph represents location information from the port of departure to the port of transshipment and thus is excluded from a comparison target.

When comparing the baseline with the collected status information, the abnormality detector 206 should perform the comparison at the same time point. For example, when the information is vessel operation information, the abnormality detector 206 calculates a vessel position in the baseline, a current position of a vessel, and a distance difference therebetween at the same time point. A case in which a vessel that is currently being monitored is ahead of the baseline does not need to be considered. However, when the vessel falls behind, the probability of occurrence of a delivery delay increases depending on the calculated distance difference.

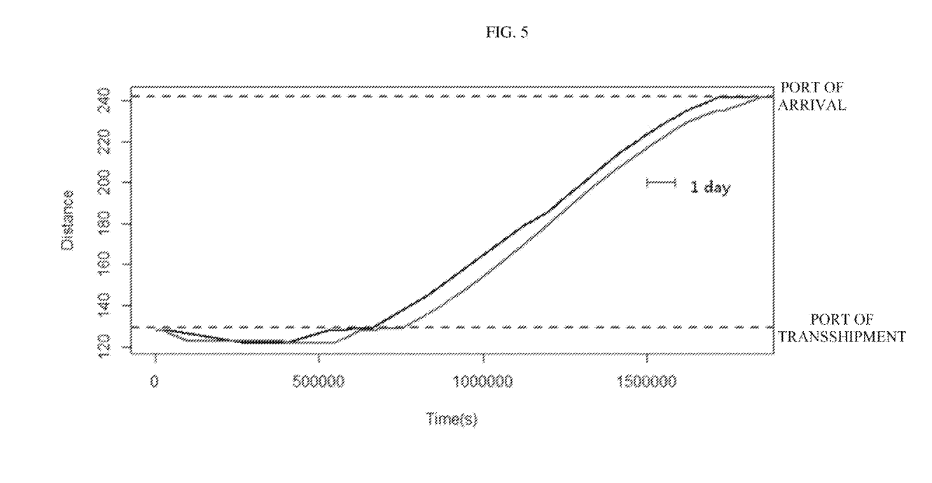

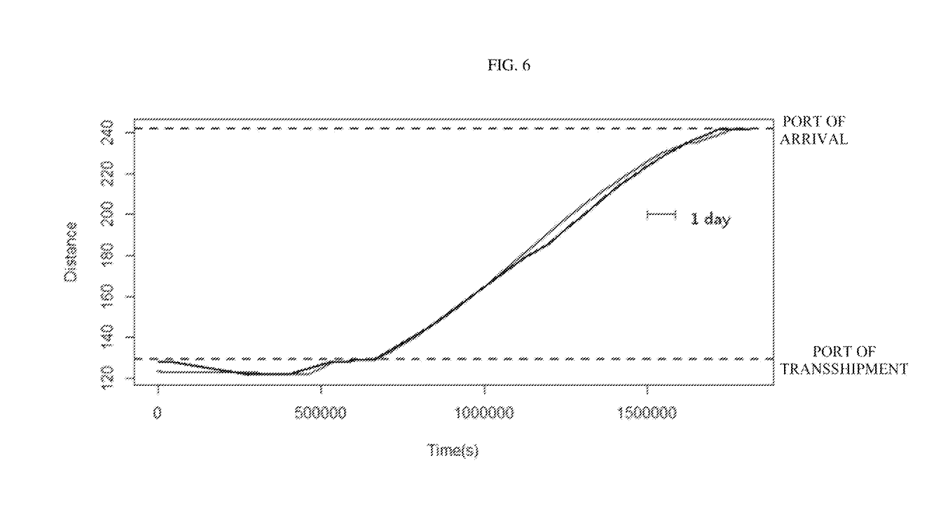

FIGS. 5 and 6 are exemplary diagrams of cases of delivery delays that may occur when location information of a vessel that is being monitored is compared with a baseline. In the graphs, black lines indicate baselines, and red lines indicate cases in which a delay has occurred. Locations of a port of transshipment and a port of arrival are represented using blue dotted lines. FIG. 5 represents a case in which a delivery delay occurs at the port of arrival, which results from a delay at the port of transshipment. FIG. 6 represents a case in which a vessel goes faster than the baseline but a delivery delay occurs at the port of arrival because the vessel slows down near the port of arrival.

The abnormality detector 206 may output an alarm message when it is determined that the monitored target 106 has an abnormality. For example, upon determining that a delay has occurred in the monitored target 106, the abnormality detector 206 may visually or acoustically notify the manager terminal 108 of this situation.

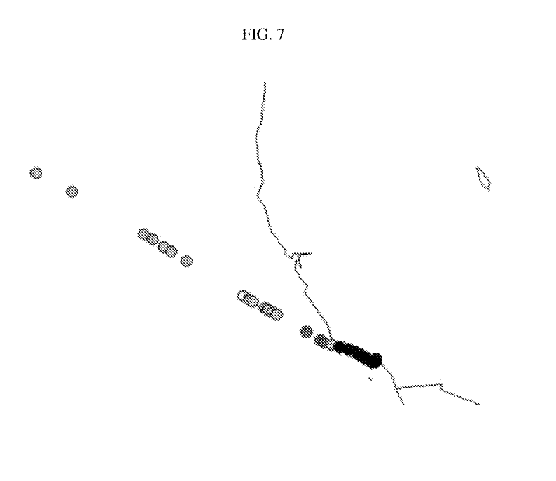

FIG. 7 is an exemplary diagram illustrating an output of a warning message from an abnormality detector 206 according to an embodiment of the present disclosure and shows an example of showing degrees of risk of a real-time delivery delay in color based on a distance between the baseline and the actual location data. When a user is warned about the degrees of risk using colors, the user easily understands the degrees of risk and quickly recognizes a delivery delay. It can be seen from FIG. 7 that a user is warned about a degree of delay by gradually changing a color in a circle from, for example, green to yellow and then to red when the vessel that is currently being monitored falls behind the baseline. A black circle around the point of arrival denotes that the vessel has already missed the time at which the vessel was scheduled to arrive at the port of arrival. When location information is collected in real time, a distance is calculated, and a warning is given as described above, the user can detect a delivery delay as soon as it occurs.

When it is detected that the monitored target 106 has an abnormality, the predictor 208 compares the selected similar cases with the collected status information to select an optimum similar case associated with the monitored target 106 among the similar cases and predicts a future situation development of the monitored target 106 based on the optimum similar case. In an example embodiment, the predicted future situation development of the monitored target may be used to inform a user of a potential delivery delay of a transshipment. Whenever the abnormality occurrence is detected, the predictor 208 compares a pattern included in each similar case that is previously selected with a pattern of the status information to select a similar case having a pattern having the highest similarity to the status information. This process is called a refinement process. In this case, the pattern may be a change in a specific feature of the monitored target over time. For example, when the monitored target 106 is a moving object, the pattern may be location information of the monitored target over time.

The predictor 208 may calculate a maximum value of similarity to the pattern of the collected status information for the pattern of each of the similar cases while moving the pattern of each of the similar cases in the same plane as the pattern of the collected status information and select, as the optimum similar case, a similar case having a largest maximum value of similarity. This will be described in more detail as follows in the case of a vessel.

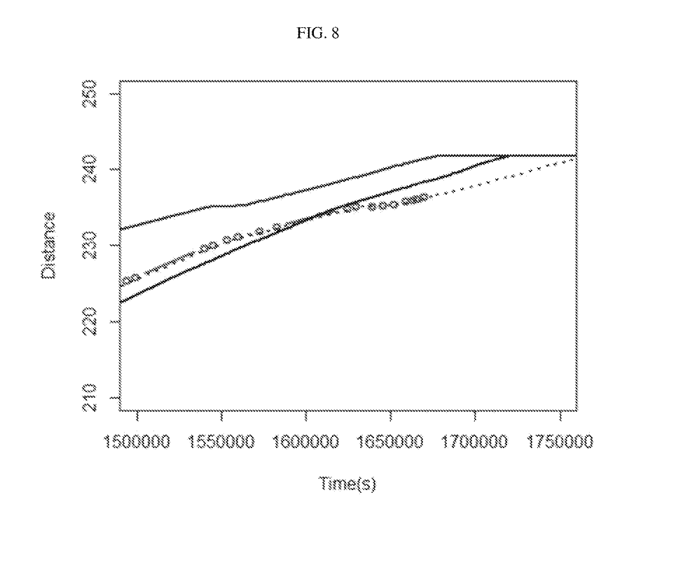

FIG. 8 is a graph illustrating an example in which a predictor 208 of the apparatus 104 for detecting an abnormality early selects an optimum similar case and compares a vessel that is being monitored with the case. In the graph, a black solid line is a baseline, a line formed of red circles is a moving pattern of a vessel being monitored, a blue solid line is a pattern of the optimum similar case, and a blue dotted line is a pattern obtained by applying the blue solid line to the monitored target case. That is, as described above, the optimum similarity case in an embodiment of the present disclosure denotes a similar case having the highest similarity when applying time-based moving patterns of the moving object, which are included in each similar case, to the monitored target, in other words, when moving a similar case to match the monitored target such that the similarity therebetween may be maximum. In this case, the similarity may be calculated using the Euclidean distance between each similar case and the monitored target case. When the moving object is a vessel, as shown in FIG. 8, the optimum similar case may be found by comparing similarities when a time-series pattern of each similar case matches a time-series pattern (a moving distance over time) of a currently moving vessel.

When the optimum similar case is selected in this way, the predictor 208 may predict a future situation development of the monitored target based on the selected optimum case. For example, when the optimum similar case selected as shown in FIG. 8 matches a time-series pattern of a currently moving vessel, the predictor 208 may predict a part indicated by the blue dotted line as a future moving pattern of a vessel being monitored. In addition, the predictor 208 may estimate a cause of an abnormality occurring in the monitored target 106 using a feature value of the optimum similar case that is stored in addition to the optimum similar case. For example, when the cause of an abnormality occurring or a parameter (weather information or discharge delay information of a port of arrival) by which the cause of an abnormality occurring may be estimated is recorded in the selected optimum similar case, the predictor 208 may estimate an abnormality occurrence cause of the monitored target 106 using the cause or the parameter.

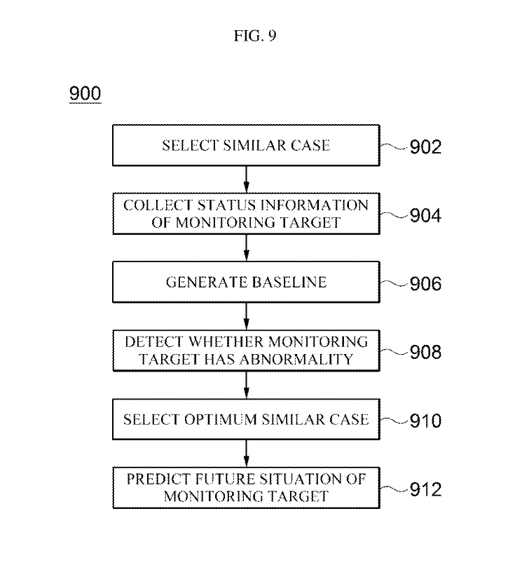

FIG. 9 is a flowchart illustrating a method 900 of detecting an abnormality early according to an embodiment of the present disclosure.

In operation 902, the similar case selector 202 of an apparatus 104 for detecting the abnormality early selects similar cases that are associated with the monitored target 106 from among previous case data.

In operation 904, the data collector 204 of the apparatus 104 for detecting the abnormality early collects status information of the monitored target 106. In operation 906, the abnormality detector 206 of the apparatus 104 for detecting the abnormality early generates a baseline for detecting the abnormality of the monitored target 106 from case data classified as normal among the previous case data.

In operation 908, the abnormality detector 206 of the apparatus 104 for detecting the abnormality early compares the baseline with the collected status information to detect whether the monitored target 106 has the abnormality.

In operation 910, when it is determined that the monitored target 106 has the abnormality, the predictor 208 of the apparatus 104 for detecting the abnormality early compares the selected similar cases and the collected status information to select an optimum similar case associated with the monitored target 106 from among the similar cases.

In operation 912, the predictor 208 of the apparatus 104 for detecting the abnormality early predicts a future situation development of the monitored target 106 based on the optimum similar case.

According to embodiments of the present disclosure, it is possible to quickly detect an abnormal situation of a monitored target by applying real-time data that is continuously generated to a similar case that is derived from a similar-based methodology.

According to embodiments of the present disclosure, it is also possible to provide meaningful information that may substantially assist in quick decision-making by effectively predicting an abnormality occurrence cause and subsequent situation development of the monitored target through the optimum similar case that is derived through comparison between the previously collected similar case and real-time data.

Embodiments of the present disclosure may include a program for performing methods described in this specification on a computer and a non-transitory computer-readable recording medium including the program. The non-transitory computer-readable recording medium may include a program instruction, a local data file, a local data structure, or a combination thereof. The medium may be designed and configured specifically for the present disclosure or can be typically available in the field of computer software. Examples of the non-transitory computer-readable recording medium include a magnetic medium, such as a hard disk, a floppy disk, and a magnetic tape, an optical recording medium, such as a CD-ROM, a DVD, etc., and a hardware device specially configured to store and perform a program instruction, such as a ROM, a RAM, a flash memory, etc. Examples of the program include a high-level language code executable by a computer with an interpreter, in addition to a machine language code made by a compiler.

Although exemplary embodiments of the disclosure have been described in detail, it will be understood by those skilled in the art that various changes may be made without departing from the spirit or scope of the disclosure. Thus, the scope of the present disclosure is to be determined by the following claims and their equivalents, and shall not be restricted or limited by the foregoing detailed description.

What is claimed is:

1. An early detection apparatus, the apparatus comprising:
a case selector configured to select cases associated with a monitored target from among previous case data;
a data collector configured to collect status information of the monitored target; and
a predictor configured to compare each of the selected cases with the collected status information to select an optimum case from among the selected cases, and to predict a future situation development of the monitored target based on the optimum similar case,
wherein the case selector, the data collector and the predictor are executed by at least one central processing unit (CPU) or at least one hardware processor.

2. The apparatus of claim 1, wherein the case selector selects the cases based on case-based reasoning using similarities between feature values of the previous case data and a feature value of the monitored target.

3. The apparatus of claim 1, further comprising an abnormality detector configured to compare case data classified as normal among the previous case data with the status information of the monitored target to detect an abnormality of the monitored target.

4. The apparatus of claim 3, wherein the abnormality detector generates a baseline for detecting the abnormality of the monitored target from the case data classified as normal, and compares the baseline with the collected status information to detect whether the monitored target has the abnormality.

5. The apparatus of claim 4, wherein the baseline is one of an average value and a median value of the case data classified as normal.

6. The apparatus of claim 4, wherein the abnormality detector determines that the monitored target has the abnormality when a difference between the collected status information and the baseline is outside a normal range.

7. The apparatus of claim 6, wherein the abnormality detector calculates a difference between the collected status information and the baseline in a preset comparison section.

8. The apparatus of claim 3, wherein the abnormality detector outputs an alarm message when it is determined that the monitored target has the abnormality.

9. The apparatus of claim 3, wherein the predictor selects the optimum case when the abnormality detector detects that the monitored target has the abnormality.

10. The apparatus of claim 1, wherein the predictor compares a pattern of each of the cases with a pattern of the collected status information and selects, as the optimum case, a case having a pattern of highest similarity to a pattern of the status information.

11. The apparatus of claim 10, wherein the predictor calculates a maximum value of similarity to the pattern of the collected status information for the pattern of each of the cases while moving the pattern of each of the cases in the same plane as the pattern of the collected status information and selects, as the optimum case, a case having a largest maximum value of similarity.

12. The apparatus of claim 1, wherein the predictor predicts the future situation development of the monitored target based on a pattern and a feature value of the selected optimum case.

13. The apparatus of claim 1, wherein the monitored target is a moving object, the previous case data is previous operation case data of the moving object, and the status information is time-based location information of the moving object.

14. A method of detecting an abnormality early, the method comprising:
selecting cases associated with a monitored target from among previous case data;
collecting status information of the monitored target;
comparing each of the cases with the collected status information to select an optimum case from among the cases; and
predicting a future situation development of the monitored target based on the optimum case.

15. The method of claim 14, wherein the selecting of the cases comprises selecting the cases based on case-based reasoning using similarities between feature values of the previous case data and a feature value of the monitored target.

16. The method of claim 14, further comprising, before the selecting of the optimum case, comparing case data classified as normal among the previous case data with the status information of the monitored target to detect an abnormality of the monitored target.

17. The method of claim 16, wherein the detecting of whether the monitored target has the abnormality further comprises:
generating a baseline for detecting the abnormality of the monitored target from the case data classified as normal; and
comparing the baseline with the collected status information.

18. The method of claim 17, wherein the baseline is one of an average value and a median value of the case data classified as normal.

19. The method of claim 17, wherein the comparing comprises determining that the monitored target has the abnormality when a difference between the collected status information and the baseline is outside a normal range.

20. The method of claim 19, wherein the comparing comprises calculating a difference between the collected status information and the baseline in a preset comparison section.

21. The method of claim 16, wherein the detecting of whether the monitored target has the abnormality further comprises outputting an alarm message when it is determined that the monitored target has the abnormality.

22. The method of claim 16, wherein the selecting of the optimum case comprises selecting the optimum case when the abnormality detector detects that the monitored target has the abnormality.

23. The method of claim 14, wherein the selecting of the optimum case comprises comparing a pattern of each of the cases with a pattern of the collected status information and selecting, as the optimum case, a case having a pattern of highest similarity to a pattern of the status information.

24. The method of claim 23, wherein the selecting of the optimum case comprises calculating a maximum value of similarity to the pattern of the collected status information for the pattern of each of the cases while moving the pattern of each of the cases in the same plane as the pattern of the collected status information and selecting, as the optimum case, a case having a largest maximum value of similarity.

25. The method of claim 14, wherein the predicting comprises predicting the future situation development of the monitored target based on a pattern and a feature value of the selected optimum case.
